(19) United States
(12) Patent Application Publication
(10) Pub. No.: US 2024/0329320 A1
(43) Pub. Date: Oct. 3, 2024

(54) DENSE PHOTONIC INTEGRATED CIRCUIT OPTICAL EDGE COUPLING

(71) Applicant: Intel Corporation, Santa Clara, CA (US)

(72) Inventors: Nicholas D. Psaila, Lanark (GB); Richard Laming, Santa Clara, CA (US)

(73) Assignee: Intel Corporation, Santa Clara, CA (US)

(21) Appl. No.: 18/565,319

(22) PCT Filed: Dec. 2, 2022
(86) PCT No.: PCT/GB2022/053080

§ 371 Date: Nov. 29, 2023

(30) Foreign Application Priority Data
Dec. 3, 2021 (GB) 2117490.9

(51) Int. Cl. G02B 6/30; G02B 6/32; G02B 6/38

(52) U.S. Cl. CPC G02B 6/305; G02B 6/32; G02B 6/3853; G02B 6/3885

(57) ABSTRACT

An optical interconnect component for use in transmitting light between a photonic integrated circuit and one or more optical fibres attached to an optical fibre connector ferrule is disclosed. The optical interconnect component comprises a step formed at an edge of the optical interconnect component, the step including a ledge and a facet, one or more optical beam management elements formed in a surface of the optical interconnect component, and a plurality of integrated optical waveguides. Each of two or more of the integrated optical waveguides extends from the facet so as to define a plurality of optical ports at the facet, and each of the one or more optical beam management elements is aligned with, but separated from, an end of a corresponding one of the plurality of integrated optical waveguides. Also disclosed are an optical fibre connector ferrule, an optical interconnect assembly comprising the optical interconnect component and the optical fibre connector ferrule, and an optical system comprising the optical interconnect assembly, a photonic integrated circuit, and one or more optical fibres.

### FIELD

The present disclosure relates to components and assemblies for assisting in high density optical edge coupling to and/or from photonic integrated circuits (PICs) such as Silicon Photonic (SiPh) devices.

### BACKGROUND

A significant requirement exists for high channel count optical input/output (I/O) ports in silicon photonic integrated circuit (PIC) applications. This is compounded by the need for tight integration between electronics and photonics in Co-packaged Optics applications (CPO), where transitioning from electronic I/O to photonic I/O can offer significant advantages and high bandwidth scalability.

Achieving high channel counts using conventional optical fiber attach processes can use an undesirable amount of space on the silicon chip which has significant cost and practicality implications.

Conventional optical fiber arrays can achieve channel pitches of the order of the 100 μm, limited by the diameter of the optical fibers used in such arrays. Common pitches are 250 μm or 127 μm, however smaller pitches are also available by using smaller diameter optical fibers such as those with an 80 μm diameter. However using one dimensional arrays of such optical fibers in conventional V-groove arrays places significant limitations on the channel densities achievable.

Optical I/O couplers on PICs can be manufactured with significantly smaller pitch between adjacent couplers such as 25 μm, and can therefore offer substantial increases in channel density. However optical interposer devices are then required to provide optical coupling between these structures and the optical fibers used to carry the signals to the receivers.

Edge-coupled optical interposer devices are commonly used on Silicon Photonic platforms to provide broad spectral bandwidth and low loss coupling to silicon photonic waveguides. However due to the edge geometry, known edge-coupled optical interposer devices are limited to 1D arrays such that reducing the channel-to-channel pitch is the only route available to increase I/O density.

Alternatively, optical interposer devices may be used which employ grating couplers to vertically couple light in and out of the silicon photonics platform. Grating couplers may allow for 2D arrays of couplers to provide more efficient use of die real-estate for 1/O. However, grating couplers typically have higher losses and polarisation sensitivity than edge couplers.

### SUMMARY

It should be understood that any one or more of the features of any one of the following aspects of the present disclosure may be combined with any one or more of the features of any of the other foregoing aspects of the present disclosure.

According to an aspect of the present disclosure there is provided an optical interconnect component for use in transmitting light between a photonic integrated circuit and one or more optical fibres attached to an optical fibre connector ferrule, the optical interconnect component comprising:
a step formed at an edge of the optical interconnect component, the step including a ledge and a facet;
one or more optical beam management elements formed in a surface of the optical interconnect component; and
a plurality of integrated optical waveguides,
wherein each of two or more of the integrated optical waveguides extends from the facet so as to define a plurality of optical ports at the facet, and
wherein each of the one or more optical beam management elements is aligned with, but separated from, an end of a corresponding one of the plurality of integrated optical waveguides.

Such an optical interconnect component may be used to transmit light between a plurality of integrated optical waveguides of the photonic integrated circuit and one or more optical fibres attached to the optical fibre connector ferrule. Such an optical interconnect component may be used for dense edge coupling between optical fibers and optical I/O ports on a photonic integrated circuit such as a silicon photonic integrated circuit.

Optionally, the optical interconnect component comprises, or is formed in, a monolithic block of material such as glass, for example a monolithic block of fused silica.

Optionally, the step is formed in the monolithic block of material.

Optionally, the one or more optical beam management elements are formed in the monolithic block of material.

Optionally, the plurality of integrated optical waveguides are formed in the monolithic block of material.

Optionally, the photonic integrated circuit comprises a plurality of integrated optical waveguides and a step formed at an edge of the photonic integrated circuit, wherein the step includes a ledge and a facet, and wherein each integrated optical waveguide of the photonic integrated circuit ends at the facet of the photonic integrated circuit so as to define a corresponding optical port at the facet of the photonic integrated circuit.

Optionally, the plurality of optical ports at the facet of the optical interconnect component has a spatial configuration which matches a spatial configuration of the plurality of optical ports at the facet of the photonic integrated circuit.

In use, the facet of the optical interconnect component is configured to engage the facet of the photonic integrated circuit so that the optical ports at the facet of the optical interconnect component are aligned with the plurality of optical ports at the facet of the photonic integrated circuit for the transmission of light between the plurality of optical ports of the photonic integrated circuit and the plurality of optical ports of the optical interconnect component.

Optionally, the optical fibre connector ferrule comprises:
one or more optical beam management elements, each optical beam management element configured for alignment with a corresponding optical beam management element of the optical interconnect component; and
one or more optical fibre alignment structures,
wherein each optical fibre alignment structure is configured for engagement with a corresponding optical fibre so that an end of the corresponding optical fibre is aligned with, but separated from, a corresponding one of the optical beam management elements of the optical fibre connector ferrule.

Optionally, wherein the one or more optical beam management elements of the optical interconnect component have a spatial configuration which matches a spatial configuration of the one or more optical beam management elements of the optical fibre connector ferrule.

Optionally, the optical fibre connector ferrule is configured for alignment with the optical interconnect component so as to align each optical beam management element of the optical fibre connector ferrule with a corresponding optical beam management element of the optical interconnect component for the transmission of light between each optical beam management element of the optical interconnect component and a corresponding optical beam management element of the optical fibre connector ferrule.

In use, the one or more optical beam management elements of the optical interconnect component and the one or more optical beam management elements of the optical fibre connector ferrule expand one or more optical beams travelling between the optical interconnect component and the optical fibre connector ferrule thereby relaxing the alignment tolerance required between the optical interconnect component and the optical fibre connector ferrule for a given optical coupling efficiency. This has the potential to simplify optical I/O assembly and packaging for photonic integrated circuits (PICs) such as Silicon Photonic (SiPh) devices.

Optionally, one or more of the optical beam management elements comprise an optical beam collimating element or an optical beam focussing element.

Optionally, one or more of the optical beam management elements comprise a microlens.

Optionally, one or more of the optical beam management elements comprise a waveguide structure such as a segmented waveguide, or a tapered waveguide.

Optionally, one or more of the optical beam management elements comprise a graded index (GRIN) lens such as a GRIN lens made by the laser modification of the refractive index of a material such as glass or a GRIN lens made by inserting a GRIN rod into a hole which is laser etched into a material of the optical interconnect component.

Optionally, one or more of the optical beam management elements comprise a 2D curved micromirror such as a 2D curved total internal reflection micromirror.

Optionally, each optical beam management element is separated from the end of the corresponding one of the plurality of integrated optical waveguides by a material of the optical interconnect component and/or by an air gap.

Optionally, the facet of the optical interconnect component is formed by etching, for example by etching the monolithic block of material.

Optionally, the ledge of the optical interconnect component is formed by etching, for example by etching the monolithic block of material.

Optionally, the facet of the photonic integrated circuit is formed by etching.

Optionally, the ledge of the photonic integrated circuit is formed by etching.

Optionally, the optical ports of the optical interconnect component and the ledge of the optical interconnect component are separated by a predetermined distance which matches a predetermined distance by which a plurality of optical ports of the photonic integrated circuit and a reference surface of the photonic integrated circuit are separated. Optionally, the step of the optical interconnect component is configured to allow engagement between the ledge of the optical interconnect component and the reference surface of the photonic integrated circuit without the ledge of the photonic integrated circuit engaging the optical interconnect component. Consequently, engagement between the ledge of the optical interconnect component and the reference surface of the photonic integrated circuit results in alignment of the optical ports of the optical interconnect component with the optical ports of the photonic integrated circuit in one dimension.

Optionally, the optical interconnect component comprises one or more fiducial markers disposed on the ledge of the optical interconnect component, each of the one or more fiducial markers being configured for alignment with one or more corresponding fiducial markers disposed on the reference surface of the photonic integrated circuit for alignment of the optical interconnect component and the photonic integrated circuit.

Optionally, the plurality of optical ports of the optical interconnect component and a reference surface of the optical interconnect component are separated by a predetermined distance which matches a predetermined distance by which the plurality of optical ports of the photonic integrated circuit and the ledge of the photonic integrated circuit are separated. Optionally, the step of the optical interconnect component is configured to allow engagement between the reference surface of the optical interconnect component and the ledge of the photonic integrated circuit without the ledge of the optical interconnect component engaging the photonic integrated circuit. Consequently, engagement between the reference surface of the optical interconnect component and the ledge of the photonic integrated circuit results in alignment of the optical ports of the optical interconnect component with the optical ports of the photonic integrated circuit in one dimension.

Optionally, the optical interconnect component comprises one or more fiducial markers disposed on the reference surface of the optical interconnect component, each of the one or more fiducial markers being configured for alignment with one or more corresponding fiducial markers disposed on the ledge of the photonic integrated circuit for alignment of the optical interconnect component and the photonic integrated circuit.

Optionally, the optical interconnect component comprises one or more alignment features, each alignment feature being configured to engage a corresponding complementary alignment feature of the photonic integrated circuit for passive alignment of the optical interconnect component and the photonic integrated circuit.

Optionally, the one or more alignment features of the optical interconnect component are formed integrally in the monolithic block of material.

Optionally, the optical interconnect component comprises one or more further alignment features, each further alignment feature being configured to engage a corresponding complementary alignment feature of the optical fibre ferrule component for passive alignment of the optical interconnect component and the optical fibre ferrule component.

Optionally, the one or more further alignment features of the optical interconnect component are formed integrally in the monolithic block of material. Optionally, the one or more further alignment features comprise one or more alignment pins or projections or one or more alignment holes. One or more of the alignment pins or projections may be formed integrally in the monolithic block of material. One or more of the alignment pins or projections may be formed separately from the monolithic block of material.

Optionally, the optical interconnect component and the optical fibre connector ferrule are configured to be detachably attached.

Optionally, the optical interconnect component and the optical fibre connector ferrule are configured to be pluggable or connectable.

Optionally, the optical ports of the optical interconnect component are arranged in a 1D array such as a uniform 1D array. Optionally, the optical ports of the optical interconnect component are arranged in a uniform 1D array on a pitch of less than 80 m.

Optionally, the optical interconnect component comprises a dispersive element, wherein the plurality of integrated optical waveguides includes a plurality of primary integrated optical waveguides and a secondary integrated optical waveguide, wherein each primary optical waveguide extends from a corresponding one of the optical ports to the dispersive element, and wherein the secondary optical waveguide extends from the dispersive element and ends at a position which is aligned with, but separated from, a corresponding one of the optical beam management elements.

Optionally, the dispersive element is configured to receive a plurality of different wavelengths via different primary integrated optical waveguides of the plurality of primary integrated optical waveguides and multiplex the plurality of different wavelengths into the secondary integrated optical waveguide or to receive a plurality of different wavelengths via the secondary integrated optical waveguide and demultiplex the plurality of different wavelengths into different primary integrated optical waveguides of the plurality of primary integrated optical waveguides.

Optionally, the dispersive element is formed integrally with the optical interconnect component.

Optionally, the dispersive element comprises one or more higher refractive index integrated optical waveguides defined in a layer of higher refractive index material which is disposed on a lower refractive index substrate of the optical interconnect component.

Optionally, one or more of the higher refractive index integrated optical waveguides are configured for evanescent coupling with one or more of the primary integrated optical waveguides and one or more of the higher refractive index integrated optical waveguides are configured for evanescent coupling with one or more of the secondary integrated optical waveguides.

Optionally, one or more of the higher refractive index integrated optical waveguides are aligned with one or more of the primary integrated optical waveguides and one or more of the higher refractive index integrated optical waveguides are aligned with one or more of the secondary integrated optical waveguides.

Optionally, the dispersive element is formed separately from the optical interconnect component and then attached to the optical interconnect component, for example by flip-chip bonding.

Optionally, the dispersive element comprises an arrayed waveguide grating (AWG), an Echelle grating or one or more bulk components such as one or more thin film interference filters located between the plurality of primary integrated optical waveguides and the secondary integrated optical waveguide.

Optionally, the one or more optical fibres comprise a plurality of optical fibres.

Optionally, each integrated optical waveguide of the plurality of integrated optical waveguides extends from the facet of the optical interconnect component so as to define the plurality of optical ports at the facet of the optical interconnect component.

Optionally, the one or more optical beam management elements comprise a plurality of optical beam management elements, and wherein an end of each integrated optical waveguide of the plurality of integrated optical waveguides is aligned with, but separated from, a corresponding one of the optical beam management elements of the optical interconnect component.

Optionally, the plurality of optical fibres comprises a 1D array of optical fibres such as a regular 1D array of optical fibres.

Optionally, the plurality of optical beam management elements comprises a 1D array of optical beam management elements such as a uniform 1D array of optical beam management elements.

Optionally, the plurality of optical fibres comprises a staggered arrangement of optical fibres.

Optionally, the plurality of optical beam management elements comprises a staggered arrangement of optical beam management elements.

Optionally, the plurality of optical fibres comprises a 2D array of optical fibres such as a regular 2D array of optical fibres.

Optionally, the plurality of optical beam management elements comprises a 2D array of optical beam management elements such as a uniform 2D array of optical beam management elements.

Optionally, formation of the optical interconnect component may comprise using a laser such as an ultrafast laser or a femtosecond laser to inscribe the monolithic block of material of the optical interconnect component in one or more regions so as to modify the material of the monolithic block of the optical interconnect component in the one or more regions.

Optionally, formation of each integrated optical waveguide comprises using a laser such as an ultrafast laser or a femtosecond laser to inscribe the monolithic block of material in one or more integrated optical waveguide regions so as to modify the material of the monolithic block in the one or more integrated optical waveguide regions.

Optionally, formation of each integrated optical waveguide comprises using a laser such as an ultrafast laser or a femtosecond laser to inscribe the monolithic block of material in one or more integrated optical waveguide regions so as to modify a refractive index of the material of the monolithic block in the one or more integrated optical waveguide regions.

Optionally, formation of each optical beam management element comprises using a laser such as an ultrafast laser or a femtosecond laser to inscribe the monolithic block of material in one or more optical beam management element regions so as to modify the material of the monolithic block in the one or more optical beam management element regions.

Optionally, formation of each optical beam management element comprises using the laser to inscribe the monolithic block of material in the one or more optical beam management element regions so as to modify a refractive index of the material of the monolithic block in the one or more optical beam management element regions.

Optionally, formation of each optical beam management element comprises using the laser to inscribe the monolithic block of material in the one or more optical beam management element regions so as to modify a chemical etchability of the material of the monolithic block in the one or more optical beam management element regions and subsequently removing the modified material of the monolithic block from the one or more optical beam management element regions, for example by chemical etching.

Optionally, formation of each optical beam management element comprises using the laser to inscribe the monolithic block of material in the one or more optical beam management element regions so as to ablate the material of the monolithic block in the one or more optical beam management element regions.

According to an aspect of the present disclosure there is provided an optical fibre connector ferrule for transmitting light between an optical interconnect component and one or more optical fibres, the optical fibre connector ferrule comprising:
one or more optical beam management elements, each optical beam management element of the optical fibre connector ferrule configured for alignment with a corresponding optical beam management element of the optical interconnect component; and
one or more optical fibre alignment structures,
wherein each optical fibre alignment structure is configured for engagement with a corresponding optical fibre so that an end of the corresponding optical fibre is aligned with, but separated from, a corresponding one of the optical beam management elements of the optical fibre connector ferrule.

Optionally, the optical fibre connector ferrule comprises, or is formed in, a monolithic block of material such as glass, for example a monolithic block of fused silica.

Optionally, the one or more optical beam management elements are formed in the monolithic block of material.

Optionally, the one or more optical fibre alignment structures are formed in the monolithic block of material.

Optionally, wherein the one or more optical beam management elements of the optical fibre connector ferrule have a spatial configuration which matches a spatial configuration of the one or more optical beam management elements of the optical interconnect component.

Optionally, the optical fibre connector ferrule is configured for alignment with the optical interconnect component so as to align each optical beam management element of the optical fibre connector ferrule with a corresponding optical beam management element of the optical interconnect component for the transmission of light between each optical beam management element of the optical interconnect component and a corresponding optical beam management element of the optical fibre connector ferrule.

Optionally, the optical fibre connector ferrule comprises one or more alignment features, each alignment feature being configured to engage a corresponding complementary alignment feature of the optical interconnect component for passive alignment of the optical fibre connector ferrule and the optical interconnect component.

Optionally, the one or more alignment features of the optical fibre connector ferrule are formed in the monolithic block of material.

Optionally, the one or more alignment features of the optical fibre connector ferrule comprise one or more alignment pins or projections or one or more alignment holes. One or more of the alignment pins or projections may be formed integrally in the monolithic block of material. One or more of the alignment pins or projections may be formed separately from the monolithic block of material.

Optionally, the optical fibre connector ferrule and the optical interconnect component are configured to be detachably attached.

Optionally, the optical fibre connector ferrule and the optical interconnect component are configured to be pluggable or connectable.

Optionally, the one or more optical fibres comprise a plurality of optical fibres.

Optionally, the plurality of optical fibres comprises a 1D array of optical fibres such as a regular 1D array of optical fibres.

Optionally, the plurality of optical fibres comprises a staggered arrangement of optical fibres.

Optionally, the plurality of optical fibres comprises a 2D array of optical fibres such as a regular 2D array of optical fibres.

Optionally, each optical fibre comprises a plurality of optical fibre cores and wherein each optical fibre alignment structure is configured to engage a corresponding optical fibre so that an end of each optical fibre core of the corresponding optical fibre is aligned with, but separated from, a corresponding one of the optical beam management elements of the optical fibre connector ferrule.

Optionally, one or more of the optical beam management elements of the optical fibre connector ferrule comprise an optical beam collimating element or an optical beam focussing element.

Optionally, one or more of the optical beam management elements of the optical fibre connector ferrule comprise a microlens.

Optionally, one or more of the optical beam management elements of the optical fibre connector ferrule comprise a waveguide structure such as a segmented waveguide, or a tapered waveguide.

Optionally, one or more of the optical beam management elements of the optical fibre connector ferrule comprise a graded index (GRIN) lens such as a GRIN lens made by the laser modification of the refractive index of a material such as glass or a GRIN lens made by inserting a GRIN rod into a hole which is laser etched into a material of the optical fibre connector ferrule.

Optionally, one or more of the optical beam management elements of the optical fibre connector ferrule comprise a 2D curved micromirror such as a 2D curved total internal reflection micromirror.

According to an aspect of the present disclosure there is provided an optical interconnect assembly for transmitting light between a photonic integrated circuit and one or more optical fibres attached to an optical fibre connector ferrule, the optical interconnect assembly comprising:
the optical interconnect component as described above; and
the optical fibre connector ferrule as described above,
wherein each optical beam management element of the optical interconnect component is aligned with a corresponding optical beam management element of the optical fibre connector ferrule.

Optionally, wherein the one or more optical beam management elements of the optical fibre connector ferrule have a spatial configuration which matches a spatial configuration of the one or more optical beam management elements of the optical interconnect component.

Optionally, the optical fibre connector ferrule and the optical interconnect component are aligned so that each optical beam management element of the optical fibre connector ferrule is aligned with a corresponding optical beam management element of the optical interconnect component for the transmission of light between each optical beam management element of the optical interconnect component and a corresponding optical beam management element of the optical fibre connector ferrule.

Optionally, the optical fibre connector ferrule and the optical interconnect component are configured to be detachably attached.

Optionally, the optical fibre connector ferrule and the optical interconnect component are configured to be pluggable or connectable.

Optionally, the one or more optical fibres comprise a plurality of optical fibres.

Optionally, the plurality of optical fibres comprises a 1D array of optical fibres such as a regular 1D array of optical fibres.

Optionally, the plurality of optical fibres comprises a staggered arrangement of optical fibres.

Optionally, the plurality of optical fibres comprises a 2D array of optical fibres such as a regular 2D array of optical fibres.

Optionally, each optical fibre comprises a plurality of optical fibre cores and wherein each optical fibre alignment structure is configured to engage a corresponding optical fibre so that an end of each optical fibre core of the corresponding optical fibre is aligned with, but separated from, a corresponding one of the optical beam management elements of the optical fibre connector ferrule.

Optionally, the optical interconnect component and the optical fibre connector ferrule have one or more complementary inter-engaging alignment features for the passive alignment of the optical interconnect component and the optical fibre connector ferrule.

Optionally, the one or more complementary inter-engaging alignment features comprise one or more alignment pins or projections and one or more complementary alignment holes. One or more of the alignment pins or projections may be formed integrally in the monolithic block of material of the optical interconnect component or formed integrally in the monolithic block of material of the optical fibre connector ferrule. One or more of the alignment pins or projections may be formed separately from the monolithic block of material of the optical interconnect component and formed separately from the monolithic block of material of the optical fibre connector ferrule.

According to an aspect of the present disclosure there is provided an optical system comprising the optical interconnect assembly as described above, a photonic integrated circuit and one or more optical fibres, wherein the photonic integrated circuit and the optical interconnect component are attached, for example bonded, and each optical fibre is attached, for example bonded, to a corresponding optical fibre alignment structure of the optical fibre connector ferrule.

Optionally, the photonic integrated circuit comprises a plurality of integrated optical waveguides and a step formed at an edge of the photonic integrated circuit, wherein the step includes a ledge and a facet, and wherein each integrated optical waveguide of the photonic integrated circuit ends at the facet of the photonic integrated circuit so as to define a corresponding optical port at the facet of the photonic integrated circuit.

Optionally, the facet of the photonic integrated circuit is formed by etching.

Optionally, the ledge of the photonic integrated circuit is formed by etching.

Optionally, the photonic integrated circuit comprises or is formed from silicon, for example wherein the photonic integrated circuit is a silicon photonic integrated circuit.

Optionally, the optical ports of the optical interconnect component and the ledge of the optical interconnect component are separated by a predetermined distance which matches a predetermined distance by which the plurality of optical ports of the photonic integrated circuit and a reference surface of the photonic integrated circuit are separated. Optionally, the step of the optical interconnect component is configured to allow engagement between the ledge of the optical interconnect component and the reference surface of the photonic integrated circuit without the ledge of the photonic integrated circuit engaging the optical interconnect component. Consequently, engagement between the ledge of the optical interconnect component and the reference surface of the photonic integrated circuit results in alignment of the optical ports of the optical interconnect component with the optical ports of the photonic integrated circuit in one dimension.

Optionally, the optical interconnect component comprises one or more fiducial markers disposed on the ledge of the optical interconnect component, each of the one or more fiducial markers being configured for alignment with one or more corresponding fiducial markers disposed on the reference surface of the photonic integrated circuit for alignment of the optical interconnect component and the photonic integrated circuit.

Optionally, the plurality of optical ports of the optical interconnect component and a reference surface of the optical interconnect component are separated by a predetermined distance which matches a predetermined distance by which the plurality of optical ports of the photonic integrated circuit and the ledge of the photonic integrated circuit are separated. Optionally, the step of the optical interconnect component is configured to allow engagement between the reference surface of the optical interconnect component and the ledge of the photonic integrated circuit without the ledge of the optical interconnect component engaging the photonic integrated circuit. Consequently, engagement between the reference surface of the optical interconnect component and the ledge of the photonic integrated circuit results in alignment of the optical ports of the optical interconnect component with the optical ports of the photonic integrated circuit in one dimension.

Optionally, the optical interconnect component comprises one or more fiducial markers disposed on the reference surface of the optical interconnect component, each of the one or more fiducial markers being configured for alignment with one or more corresponding fiducial markers disposed on the ledge of the photonic integrated circuit for alignment of the optical interconnect component and the photonic integrated circuit.

Optionally, the one or more optical fibres comprise a plurality of optical fibres.

Optionally, the plurality of optical fibres comprises a 1D array of optical fibres such as a regular 1D array of optical fibres.

Optionally, the plurality of optical fibres comprises a staggered arrangement of optical fibres.

Optionally, the plurality of optical fibres comprises a 2D array of optical fibres such as a regular 2D array of optical fibres.

### BRIEF DESCRIPTION OF THE DRAWINGS

Optical interconnect components, optical fibre connector ferrules, optical interconnect assemblies, and optical systems will now be described by way of non-limiting example only with reference to the accompanying drawings of which:

FIG. 1A is a schematic side view of a first optical interconnect assembly comprising a first optical interconnect component and a first optical fibre connector ferrule in use transmitting light between a photonic integrated circuit and one or more optical fibres attached to the first optical fibre connector ferrule;

FIG. 1B is a schematic end view of the photonic integrated circuit shown in FIG. 1A;

FIG. 1C is a schematic perspective view of the first optical interconnect component of the first optical interconnect assembly of FIG. 1A:

FIG. 2A is a schematic side view of a second optical interconnect assembly comprising a second optical interconnect component and a second optical fibre connector ferrule for transmitting light between a photonic integrated circuit and one or more optical fibres attached to the second optical fibre connector ferrule;

FIG. 2B is a schematic perspective view of the second optical interconnect component of the second optical interconnect assembly of FIG. 2A;

FIG. 3 is a schematic side view of a third optical interconnect assembly comprising a third optical interconnect component and a third optical fibre connector ferrule for transmitting light between a photonic integrated circuit and one or more optical fibres attached to the third optical fibre connector ferrule;

FIG. 4A is a schematic side view of a fourth optical interconnect assembly comprising a third optical interconnect component and a fourth optical fibre connector ferrule for transmitting light between a photonic integrated circuit and one or more optical fibres attached to the fourth optical fibre connector ferrule;

FIG. 4B is a schematic plan view of the fourth optical interconnect component of the fourth optical interconnect assembly of FIG. 4A;

FIG. 5 is a schematic side view of a part of a fifth optical interconnect assembly comprising a fifth optical interconnect component and a fifth optical fibre connector ferrule for transmitting light between a photonic integrated circuit and one or more optical fibres attached to the fifth optical fibre connector ferrule;

FIG. 6 is a schematic perspective view of a sixth optical interconnect component; and

FIG. 7 is a schematic plan view of an alternative optical fibre connector ferrule.

### DETAILED DESCRIPTION OF THE DRAWINGS

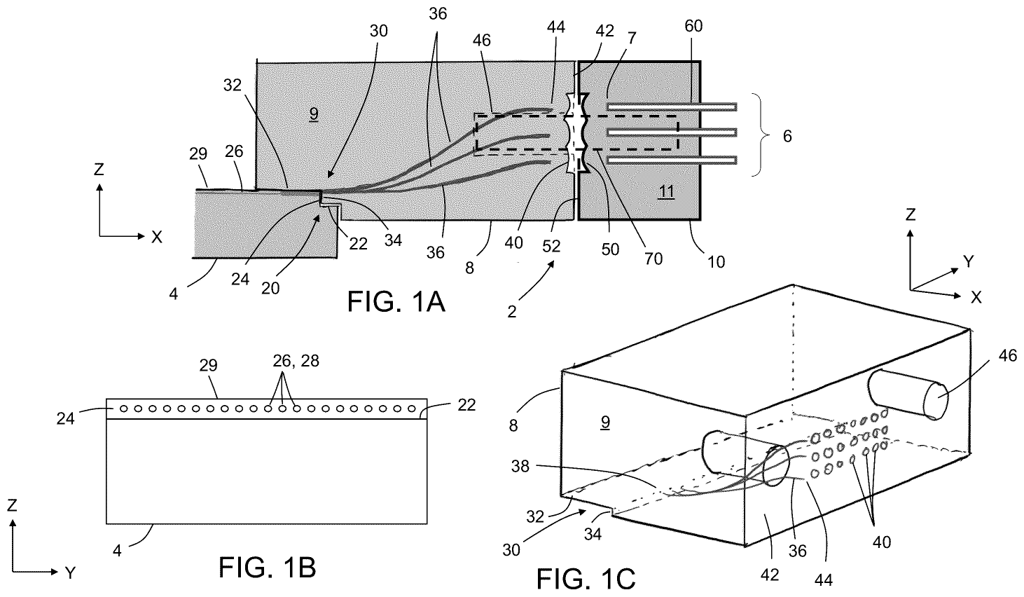

Referring initially to FIG. 1A there is shown a schematic side view of a first optical interconnect assembly generally designated 2 for transmitting light between a photonic integrated circuit in the form of a silicon photonic integrated circuit 4 and a plurality of optical fibres 6. The optical interconnect assembly 2 includes an optical interconnect component 8 and an optical fibre connector ferrule 10. As will be described in more detail below, the optical interconnect component 8 is attached to the photonic integrated circuit 4, and the plurality of optical fibres 6 are attached to the optical fibre connector ferrule 10.

As shown FIGS. 1A and 1B, the photonic integrated circuit 4 includes a step generally designated 20 formed at an edge of the photonic integrated circuit 4, wherein the step 20 includes a ledge 22 and a facet 24. The photonic integrated circuit 4 further includes a plurality of integrated optical waveguides 26, wherein each integrated optical waveguide 26 of the photonic integrated circuit 4 ends at the facet 24 of the photonic integrated circuit 4 so as to define a corresponding optical port 28 at the facet 24 of the photonic integrated circuit 4. The plurality of integrated optical waveguides 26 are configured so that the optical ports 28 are arranged in a uniform 1D array. Each optical port 28 of the photonic integrated circuit 4 is defined at a predetermined distance from an upper reference surface 29 of the photonic integrated circuit 4. One of ordinary skill in the art will understand that the ledge 22 and/or the facet 24 of the photonic integrated circuit 4 may be formed by etching. Moreover, the upper reference surface 29 of the photonic integrated circuit 4 may be polished.

As shown FIGS. 1A and 1C, the optical interconnect component 8 is formed in a monolithic block of material in the form of a monolithic block of fused silica 9 and includes a step generally designated 30 formed at an edge of the optical interconnect component 8. The step 30 includes a ledge 32 and a facet 34, wherein the facet 34 is configured for engagement with the facet 24 of the photonic integrated circuit 4. One of ordinary skill in the art will understand that the ledge 32 of the optical interconnect component 8 and/or the facet 34 of the optical interconnect component 8 may be formed by etching the monolithic block of fused silica 9.

The optical interconnect component 8 further includes a plurality of integrated optical waveguides 36 formed in the monolithic block of fused silica 9, wherein each integrated optical waveguide 36 of the optical interconnect component 8 ends at the facet 34 of the optical interconnect component 8 so as to define a corresponding optical port 38 at the facet 24 of the optical interconnect component 8. The plurality of integrated optical waveguides 36 are configured so that the optical ports 38 are arranged in a uniform 1D array which has a spatial configuration which matches a spatial configuration of the uniform 1D array of the optical ports 28 of the photonic integrated circuit 4. Each optical port 38 of the optical interconnect component 8 is defined at a predetermined distance from the ledge 32 of the optical interconnect component 8 which matches the predetermined distance between each optical port 28 of the photonic integrated circuit 4 and the upper reference surface 29 of the photonic integrated circuit 4. One of ordinary skill in the art will understand that the step 30 of the optical interconnect component 8 is configured to allow engagement between the ledge 32 of the optical interconnect component 8 and the upper reference surface 29 of the photonic integrated circuit 4 without the optical interconnect component 8 engaging the ledge 22 of the photonic integrated circuit 4. Consequently, alignment of the optical ports 28 of the photonic integrated circuit 4 and the optical ports 38 of the optical interconnect component 8 is achieved automatically in the Z-direction when the ledge 32 of the optical interconnect component 8 engages the upper reference surface 29 of the photonic integrated circuit 4.

Furthermore, the optical interconnect component 8 and the photonic integrated circuit 4 may be aligned in X and Y using a vision system. For example, the optical interconnect component 8 may comprise one or more fiducial markers (not shown in FIGS. 1A-1C) disposed on the ledge 32 and the photonic integrated circuit 4 may comprise one or more corresponding fiducial markers (not shown in FIGS. 1A-1C) disposed on the upper reference surface 29 of the photonic integrated circuit 4. The one or more fiducial markers disposed on the ledge 32 of the optical interconnect component 8 and the one or more corresponding fiducial markers disposed on the upper reference surface 29 of the photonic integrated circuit 4 may be aligned in X and Y using a vision system.

Alternatively, the optical interconnect component 8 and the photonic integrated circuit 4 may comprise one or more complementary features (not shown in FIGS. 1A-1C) which are configured for inter-engagement so as to align the optical interconnect component 8 and the photonic integrated circuit 4 in X and Y. For example, one of the optical interconnect component 8 and the photonic integrated circuit 4 may comprise a stand-off, pillar or a projection and the other of the optical interconnect component 8 and the photonic integrated circuit 4 may comprise a complementary recess for receiving the stand-off, pillar or projection so as to align the optical interconnect component 8 and the photonic integrated circuit 4 in X and Y.

In addition, although not shown in FIGS. 1A-1C, the ledge 32 and/or the facet 34 of the optical interconnect component 8 may have one or more recesses or channels formed therein to assist with the flow of an adhesive fluid such as epoxy for the attachment of the optical interconnect component 8 and the photonic integrated circuit 4. Such recesses or channels may, in effect, help to control the thickness of the bond-line between the optical interconnect component 8 and the photonic integrated circuit 4 and thereby provide a more robust attachment between the optical interconnect component 8 and the photonic integrated circuit 4.

The optical interconnect component 8 further includes a plurality of optical beam management elements in the form of a plurality of microlenses 40 formed in the monolithic block of fused silica 9 at an end surface 42 of the optical interconnect component 8 and arranged in a uniform 2D array. Each of the microlenses 40 of the optical interconnect component 8 is aligned with, but separated from, an end 44 of a corresponding one of the plurality of integrated optical waveguides 36.

The optical interconnect component 8 also includes a pair of alignment features in the form of a pair of alignment holes 46 formed in the monolithic block of fused silica 9 for use in aligning the optical interconnect component 8 and the optical fibre connector ferrule 10.

As will be understood from the foregoing description of FIGS. 1A-1C, the plurality of integrated optical waveguides 36 of the optical interconnect component 8 are arranged to route light between the uniform 1D array of optical ports 38 of the optical interconnect component 8 and the uniform 2D array of microlenses 40 formed in the end surface 42 of the optical interconnect component 8.

The optical fibre connector ferrule 10 is formed in a monolithic block of material in the form of a monolithic block of fused silica 11 and includes a plurality of optical beam management elements in the form of a plurality of microlenses 50 formed in an end surface 52 of the optical fibre connector ferrule 10 and arranged in a uniform 2D array. The spatial configuration of the 2D array of microlenses 50 of the optical fibre connector ferrule 10 matches the spatial configuration of the 2D array of microlenses 40 of the optical interconnect component 8.

The optical fibre connector ferrule 10 further includes a plurality of optical fibre alignment structures in the form of a uniform 2D array of optical fibre alignment holes 60 formed in the monolithic block of fused silica 11, each optical fibre alignment hole 60 being configured to accommodate an end section of a corresponding optical fibre 6 so that an end 7 of the corresponding optical fibre 6 is aligned with, but separated from, a corresponding one of the microlenses 50 of the optical fibre connector ferrule 10.

Moreover, although not shown in FIG. 1A, the optical fibre connector ferrule 10 includes one or more passages or channels extending between a surface of the optical fibre connector ferrule 10 and each optical fibre alignment hole 60 to assist with the flow of an adhesive fluid such as epoxy for the attachment of each optical fibre 6 in the corresponding optical fibre alignment hole 60. The optical fibre connector ferrule 10 further includes alignment features in the form of pins 70 formed in the monolithic block of fused silica 11, wherein each pin 70 is configured to be received in a corresponding one of the holes 46 of the optical interconnect component 8 for the passive alignment of the optical interconnect component 8 and the optical fibre connector ferrule 10. Specifically, the alignment holes 46 of the optical interconnect component 8 are positioned relative to the microlenses 40 of the optical interconnect component 8, and the pins 70 of the optical fibre connector ferrule 10 are positioned relative to the microlenses 50 of the optical fibre connector ferrule 10 to ensure that the microlenses 40 of the optical interconnect component 8 and the microlenses 50 of the optical fibre connector ferrule 10 are passively aligned when the pins 70 of the optical fibre connector ferrule 10 are inserted into the alignment holes 46 of the optical interconnect component 8.

In use, when the pins 70 of the optical fibre connector ferrule 10 are inserted into the alignment holes 46 of the optical interconnect component 8, light is transmitted between the integrated optical waveguides 26 of the photonic integrated circuit 4 and the optical fibres 6 via the optical interconnect component 8 and the optical fibre connector ferrule 10. The 2D array of microlenses 40 of the optical interconnect component 8 and the 2D array of microlenses 50 of the optical fibre connector ferrule 10 serve to form a 2D array of expanded collimated optical beams which are transmitted horizontally between the optical interconnect component 8 and the optical fibre connector ferrule 10 thereby relaxing the alignment tolerance required between the optical interconnect component 8 and the optical fibre connector ferrule 10 for a given optical coupling efficiency.

From the foregoing description, it will be understood that the optical interconnect component 8 and the optical fibre connector ferrule 10 serve to optically couple the uniform 1D array of optical ports 28 of the photonic integrated circuit 4 and the uniform 2D array of optical fibres 6 thereby enabling higher density optical I/O than the optical I/O densities achievable using prior art optical interconnects. Moreover, the optical fibre connector ferrule 10 is pluggable or connectable to the optical interconnect component 8 in a horizontal direction i.e. in a direction which is parallel to a direction between the photonic integrated circuit 4 and the optical interconnect component 8. The optical interconnect component 8 and the optical fibre connector ferrule 10 may also be detachably attachable. For example, although not shown in FIG. 1A or 1C, the optical interconnect component 8 may include one or more mechanical features such as one or more notches and the optical fibre connector ferrule 10 may include one or more mechanical features such as one or more arms, clips or clamps which are complementary to one or more notches of the optical interconnect component 8 and which are configured to engage the one or more notches of the optical interconnect component 8 for connecting, latching or holding the optical interconnect component 8 and the optical fibre connector ferrule 10 together.

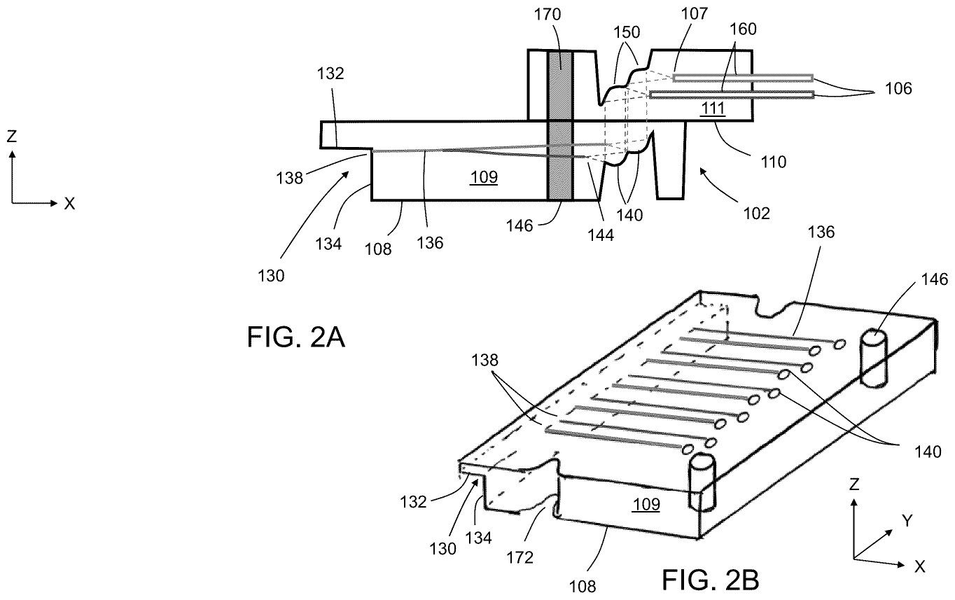

Referring to FIG. 2A there is shown a schematic side view of a second optical interconnect assembly generally designated 102 for transmitting light between a photonic integrated circuit in the form of a silicon photonic integrated circuit (not shown) and a plurality of optical fibres 106. The optical interconnect assembly 102 includes an optical interconnect component 108 and an optical fibre connector ferrule 110. As will be described in more detail below, the optical interconnect component 108 is configured for attachment to the photonic integrated circuit and the plurality of optical fibres 106 are attached to the optical fibre connector ferrule 110.

As shown in FIGS. 2A and 2B, the optical interconnect component 108 is formed in a monolithic block of material in the form of a monolithic block of fused silica 109 and includes a step generally designated 130 formed at an edge of the optical interconnect component 108. The step 130 includes a ledge 132 and a facet 134, wherein the facet 134 is configured for engagement with a facet of a photonic integrated circuit. One of ordinary skill in the art will understand that the ledge 132 and/or the facet 134 of the optical interconnect component 108 may be formed by etching the monolithic block of fused silica 109.

The optical interconnect component 108 further includes a plurality of integrated optical waveguides 136 formed in the monolithic block of fused silica 109, wherein each integrated optical waveguide 136 of the optical interconnect component 108 ends at the facet 134 of the optical interconnect component 108 so as to define a corresponding optical port 138 at the facet 124 of the optical interconnect component 108. The plurality of integrated optical waveguides 136 are configured so that the optical ports 138 are arranged in a uniform 1D array which has a spatial configuration which matches a spatial configuration of a uniform 1D array of optical ports of the photonic integrated circuit. Each optical port 138 of the optical interconnect component 108 is defined at a predetermined distance from the ledge 132 of the optical interconnect component 108. One of ordinary skill in the art will understand that the step 130 of the optical interconnect component 108 is configured to allow engagement between the ledge 132 of the optical interconnect component 108 and an upper reference surface of the photonic integrated circuit without a ledge of the photonic integrated circuit engaging the optical interconnect component 108. As described above in relation to the photonic integrated circuit 4 and the interconnect component 8 with reference to FIGS. 1A-1C, this should result in the alignment of a plurality of optical ports of the photonic integrated circuit and the optical ports 138 of the optical interconnect component 108 in the Z-direction when the ledge 132 of the optical interconnect component 108 engages the upper reference surface of the photonic integrated circuit.

Furthermore, the optical interconnect component 108 and the photonic integrated circuit may be aligned in X and Y using a vision system. For example, the optical interconnect component 108 may comprise one or more fiducial markers (not shown in FIGS. 2A and 2B) disposed on the ledge 132 and the photonic integrated circuit may comprise one or more corresponding fiducial markers disposed on the upper reference surface of the photonic integrated circuit. The one or more fiducial markers disposed on the ledge 132 of the optical interconnect component 108 and the one or more corresponding fiducial markers disposed on the upper reference surface of the photonic integrated circuit may be aligned in X and Y using a vision system.

Alternatively, the optical interconnect component 108 and the photonic integrated circuit may comprise one or more complementary features (not shown in FIGS. 2A and 2B) which are configured for inter-engagement so as to align the optical interconnect component 108 and the photonic integrated circuit in X and Y. For example, one of the optical interconnect component 108 and the photonic integrated circuit may comprise a stand-off, pillar or a projection and the other of the optical interconnect component 108 and the photonic integrated circuit may comprise a complementary recess for receiving the stand-off, pillar or projection so as to align the optical interconnect component 108 and the photonic integrated circuit in X and Y.

In addition, although not shown in FIGS. 2A and 2B, the ledge 132 and/or the facet 134 of the optical interconnect component 108 may have one or more recesses or channels formed therein to assist with the flow of an adhesive fluid such as epoxy for the attachment of the optical interconnect component 108 and the photonic integrated circuit. Such recesses or channels may, in effect, help to control the thickness of the bond-line and thereby provide a more robust attachment between the optical interconnect component 108 and the photonic integrated circuit.

The optical interconnect component 108 further includes a plurality of optical beam management elements in the form of a plurality of 2D curved total internal reflection (TIR) micromirrors 140 formed on an underside of the optical interconnect component 108 in the monolithic block of fused silica 109 and arranged in a staggered pattern. Each of the 2D curved micromirrors 140 of the optical interconnect component 108 is aligned with, but separated from, an end 144 of a corresponding one of the plurality of integrated optical waveguides 136.

The optical interconnect component 108 also includes one or more alignment features in the form of a pair of alignment holes 146 formed in the monolithic block of fused silica 109 for use in aligning the optical interconnect component 108 and the optical fibre connector ferrule 110. The optical interconnect component 108 also includes one or more mechanical features in the form of a pair of notches 172 formed in the monolithic block of fused silica 109 for engagement by one or more arms, clips or clamps (not shown) of the optical fibre connector ferrule 110 so as to connect, latch or hold the optical interconnect component 108 and the optical fibre connector ferrule 110 together and thereby detachably attach the optical interconnect component 108 and the optical fibre connector ferrule 110.

As will be understood from the foregoing description of FIGS. 2A and 2B, the plurality of integrated optical waveguides 136 of the optical interconnect component 108 are arranged to route light between the uniform 1D array of optical ports 138 of the optical interconnect component 108 and the staggered arrangement of 2D curved micromirrors 140. Specifically, alternate integrated optical waveguides 136 are used to route light up and down in Z to address 2D curved micromirrors 140 in different columns of the staggered arrangement of 2D curved micromirrors 140.

The optical fibre connector ferrule 110 is formed in a monolithic block of material in the form of a monolithic block of fused silica 111 and includes a plurality of optical beam management elements in the form of a plurality of 2D curved total internal reflection (TIR) micromirrors 150 formed in an upper surface of the optical fibre connector ferrule 110 and arranged in a staggered pattern which matches the staggered pattern of the 2D curved micromirrors 140 of the optical interconnect component 108.

The optical fibre connector ferrule 110 further includes a plurality of optical fibre alignment structures in the form of a staggered array of optical fibre alignment holes 160 formed in the monolithic block of fused silica 111, each optical fibre alignment hole 160 being configured to accommodate an end section of a corresponding optical fibre 106 so that an end 107 of the corresponding optical fibre 106 is aligned with, but separated from, a corresponding one of the 2D curved micromirrors 150 of the optical fibre connector ferrule 110. Moreover, although not shown in FIG. 2A, the optical fibre connector ferrule 110 includes one or more passages or channels extending between a surface of the optical fibre connector ferrule 110 and each optical fibre alignment hole 160 to assist with the flow of an adhesive fluid such as epoxy for the attachment of each optical fibre 106 in the corresponding optical fibre alignment hole 160.

The optical fibre connector ferrule 110 further includes pins 170 formed in the monolithic block of fused silica 111, wherein each pin 170 is configured to be received in a corresponding one of the holes 146 of the optical interconnect component 108 for the passive alignment of the optical interconnect component 108 and the optical fibre connector ferrule 110. Specifically, the alignment holes 146 of the optical interconnect component 108 are positioned relative to the 2D curved micromirrors 140 of the optical interconnect component 108, and the pins 170 of the optical fibre connector ferrule 110 are positioned relative to the 2D curved micromirrors 150 of the optical fibre connector ferrule 110 to ensure that the 2D curved micromirrors 140 of the optical interconnect component 108 and the 2D curved micromirrors 150 of the optical fibre connector ferrule 110 are passively aligned when the pins 170 of the optical fibre connector ferrule 110 are inserted into the alignment holes 146 of the optical interconnect component 108.

Although not shown in FIG. 2A, it should be understood that the optical fibre connector ferrule 110 also includes one or more mechanical features such as one or more arms, clips or clamps (not shown) which are complementary to the notches 172 of the optical interconnect component 108 and which are configured to engage the notches 172 of the optical interconnect component 108 so as to connect, latch or hold the optical interconnect component 108 and the optical fibre connector ferrule 110 together so as to detachably attach the optical interconnect component 108 and the optical fibre connector ferrule 110.

In use, when the pins 170 of the optical fibre connector ferrule 110 are inserted into the alignment holes 146 of the optical interconnect component 108, light is transmitted between integrated optical waveguides of the photonic integrated circuit and the optical fibres 106 via the optical interconnect component 108 and the optical fibre connector ferrule 110. The staggered arrangement of 2D curved micromirrors 140 of the optical interconnect component 108 and the staggered arrangement of 2D curved micromirrors 150 of the optical fibre connector ferrule 110 serve to form a staggered arrangement of expanded collimated optical beams which are transmitted vertically between the optical interconnect component 108 and the optical fibre connector ferrule 110 thereby relaxing the alignment tolerance required between the optical interconnect component 108 and the optical fibre connector ferrule 110 for a given optical coupling efficiency.

From the foregoing description, it will be understood that the optical interconnect component 108 and the optical fibre connector ferrule 110 serve to optically couple a uniform 1D array of optical ports of a photonic integrated circuit and the staggered array of optical fibres 106 thereby enabling higher density optical I/O than the optical I/O densities achievable using prior art optical interconnects. Moreover, the optical fibre connector ferrule 110 is pluggable or connectable to the optical interconnect component 108 in a vertical direction i.e. in a direction which is perpendicular to a direction between the photonic integrated circuit and the optical interconnect component 108. This may be advantageous because plugging or unplugging the optical fibre connector ferrule 110 and the optical interconnect component 108 may exert forces which are perpendicular to the direction between the photonic integrated circuit and the optical interconnect component 108, thereby exerting less force on a bond-line between the photonic integrated circuit and the optical interconnect component 108 and optionally also exerting less force on the photonic integrated circuit. Moreover, it should be understood that the photonic integrated circuit may extend at least partially underneath the optical interconnect component 108 so as to support the optical interconnect component 108 when the optical fibre connector ferrule 110 and the optical interconnect component 108 are plugged or unplugged.

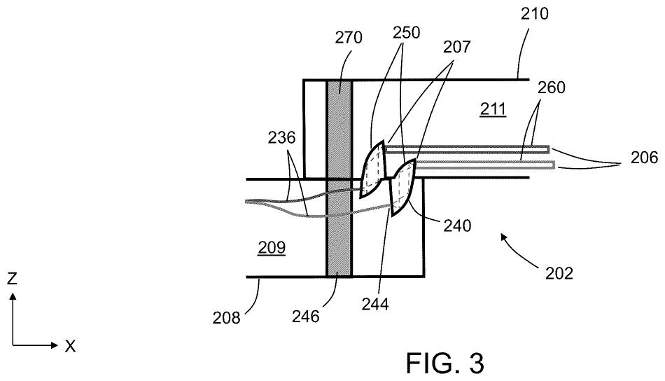

FIG. 3 shows a schematic side view of part of a third optical interconnect assembly generally designated 202 for transmitting light between a photonic integrated circuit in the form of a silicon photonic integrated circuit (not shown) and a plurality of optical fibres 206 which shares many like features with the second optical interconnect assembly 102 of FIGS. 2A and 2B, with the features of the third optical interconnect assembly 202 of FIG. 3 having the same reference numerals as like features of the second optical interconnect assembly 102 of FIGS. 2A and 2B incremented by “100”. The optical interconnect assembly 202 includes an optical interconnect component 208 and an optical fibre connector ferrule 210. The optical interconnect component 208 is formed in a monolithic block of material in the form of a monolithic block of fused silica 209 and includes a plurality of integrated optical waveguides 236 and a plurality of 2D curved micromirrors 240 formed in an upper surface of the optical interconnect component 208. The plurality of 2D curved micromirrors 240 are arranged in a staggered pattern like the staggered pattern of the 2D curved micromirrors 140 shown in FIG. 2B. Each of the 2D curved micromirrors 240 of the optical interconnect component 208 is aligned with, but separated from, an end 244 of a corresponding integrated optical waveguide 236. The optical fibre connector ferrule 210 is formed in a monolithic block of material in the form of a monolithic block of fused silica 211 and includes a plurality of 2D curved micromirrors 250 formed in a lower surface of the optical fibre connector ferrule 210. The plurality of 2D curved micromirrors 250 is arranged in a staggered pattern which matches the staggered pattern of the 2D curved micromirrors 240. The optical fibre connector ferrule 210 further includes a plurality of optical fibre alignment structures in the form of a staggered array of optical fibre alignment holes 260 formed in the monolithic block of fused silica 211. Each of the 2D curved micromirrors 250 of the optical fibre connector ferrule 210 is aligned with, but separated from, an end 207 of a corresponding optical fibre 206 located in a corresponding optical fibre alignment hole 260.

The optical interconnect component 208 includes alignment holes 246 formed in the monolithic block of fused silica 209 for use in aligning the optical interconnect component 208 and the optical fibre connector ferrule 110. The optical fibre connector ferrule 210 includes pins 270 formed in the monolithic block of fused silica 111 for use in aligning the optical interconnect component 208 and the optical fibre connector ferrule 110. Specifically, the alignment holes 246 of the optical interconnect component 208 are positioned relative to the microlenses 240 of the optical interconnect component 208, and the pins 270 of the optical fibre connector ferrule 210 are positioned relative to the microlenses 250 of the optical fibre connector ferrule 210 to ensure that the microlenses 240 of the optical interconnect component 208 and the microlenses 250 of the optical fibre connector ferrule 210 are passively aligned when the pins 270 of the optical fibre connector ferrule 210 are inserted into the alignment holes 246 of the optical interconnect component 208.

In use, when the pins 270 of the optical fibre connector ferrule 210 are inserted into the alignment holes 246 of the optical interconnect component 208, light is transmitted between the integrated optical waveguides of the photonic integrated circuit and the optical fibres 206 via the optical interconnect component 208 and the optical fibre connector ferrule 210. The staggered arrangement of microlenses 240 of the optical interconnect component 208 and the staggered arrangement of microlenses 250 of the optical fibre connector ferrule 210 serve to form a staggered arrangement of expanded collimated optical beams which are transmitted vertically between the optical interconnect component 208 and the optical fibre connector ferrule 210 thereby relaxing the alignment tolerance required between the optical interconnect component 208 and the optical fibre connector ferrule 210 for a given optical coupling efficiency.

In other aspects, the third optical interconnect assembly 202 of FIG. 3 resembles the second optical interconnect assembly 102 of FIG. 2A.

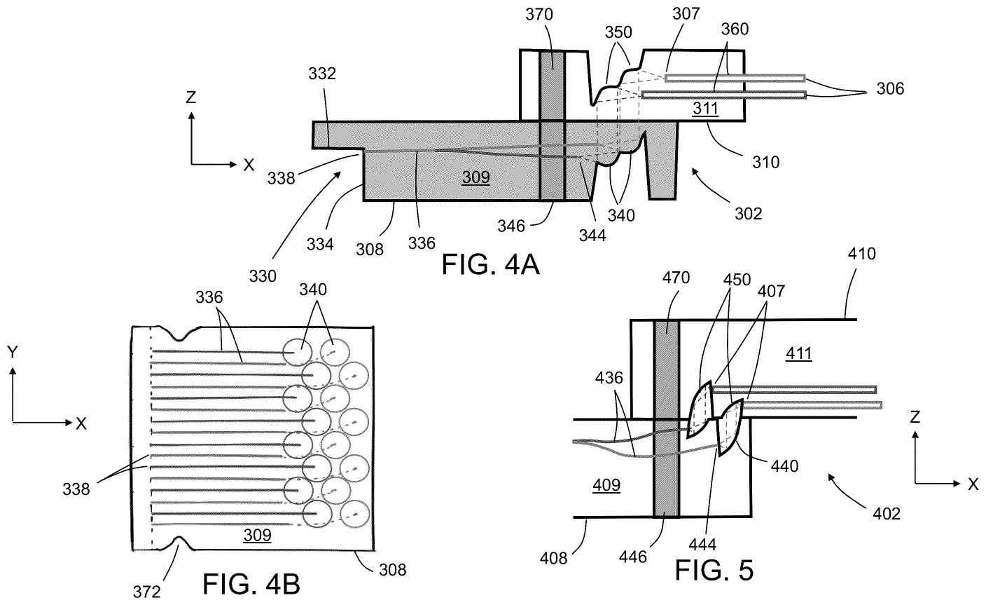

Referring to FIG. 4A there is shown a schematic side view of a fourth optical interconnect assembly generally designated 302 for transmitting light between a photonic integrated circuit in the form of a silicon photonic integrated circuit (not shown) and a plurality of optical fibres 306. The optical interconnect assembly 302 includes an optical interconnect component 308 and an optical fibre connector ferrule 310. As will be described in more detail below, the optical interconnect component 308 is configured for attachment to the photonic integrated circuit and the plurality of optical fibres 306 are attached to the optical fibre connector ferrule 310.

The optical interconnect component 308 is formed in a monolithic block of material in the form of a monolithic block of fused silica 309 and includes a step generally designated 330 formed at an edge of the optical interconnect component 308. The step 330 includes a ledge 332 and a facet 334, wherein the facet 334 is configured for engagement with a facet of a photonic integrated circuit. One of ordinary skill in the art will understand that the ledge 332 and/or the facet 334 of the optical interconnect component 308 may be formed by etching the monolithic block of fused silica 309.

The optical interconnect component 308 further includes a plurality of integrated optical waveguides 336 formed in the monolithic block of fused silica 309, wherein each integrated optical waveguide 336 of the optical interconnect component 308 ends at the facet 334 of the optical interconnect component 308 so as to define a corresponding optical port 338 at the facet 324 of the optical interconnect component 308. The plurality of integrated optical waveguides 336 are configured so that the optical ports 338 are arranged in a uniform 1D array which has a spatial configuration which matches a spatial configuration of a uniform 1D array of optical ports of the photonic integrated circuit. Each optical port 338 of the optical interconnect component 308 is defined at a predetermined distance below the ledge 332 of the optical interconnect component 308. One of ordinary skill in the art will understand that the step 330 of the optical interconnect component 308 is configured to allow engagement between the ledge 332 of the optical interconnect component 308 and an upper reference surface of the photonic integrated circuit without a ledge of the photonic integrated circuit engaging the optical interconnect component 308. As described above in relation to the photonic integrated circuit 4 and the interconnect component 8 with reference to FIGS. 1A-1C, this should result in the alignment of a plurality of optical ports of the photonic integrated circuit and the optical ports 338 of the optical interconnect component 308 in the Z-direction when the ledge 332 of the optical interconnect component 308 engages the upper reference surface of the photonic integrated circuit.

Furthermore, the optical interconnect component 308 and the photonic integrated circuit may be aligned in X and Y using a vision system. For example, the optical interconnect component 308 may comprise one or more fiducial markers (not shown in FIGS. 4A and 4B) disposed on the ledge 332 and the photonic integrated circuit may comprise one or more corresponding fiducial markers disposed on the upper reference surface of the photonic integrated circuit. The one or more fiducial markers disposed on the ledge 332 of the optical interconnect component 308 and the one or more corresponding fiducial markers disposed on the upper reference surface of the photonic integrated circuit may be aligned in X and Y using a vision system.

Alternatively, the optical interconnect component 308 and the photonic integrated circuit may comprise one or more complementary features (not shown in FIGS. 4A and 4B) which are configured for inter-engagement so as to align the optical interconnect component 308 and the photonic integrated circuit in X and Y. For example, one of the optical interconnect component 308 and the photonic integrated circuit may comprise a stand-off, pillar or a projection and the other of the optical interconnect component 308 and the photonic integrated circuit may comprise a complementary recess for receiving the stand-off, pillar or projection so as to align the optical interconnect component 1308 and the photonic integrated circuit in X and Y.

In addition, although not shown in FIGS. 4A and 4B, the ledge 332 and/or the facet 334 of the optical interconnect component 308 may have one or more recesses or channels formed therein to assist with the flow of an adhesive fluid such as epoxy for the attachment of the optical interconnect component 308 and the photonic integrated circuit. Such recesses or channels may, in effect, help to control the thickness of the bond-line and thereby provide a more robust attachment between the optical interconnect component 308 and the photonic integrated circuit.

The optical interconnect component 308 further includes a plurality of optical beam management elements in the form of a plurality of 2D curved total internal reflection (TIR) micromirrors 340 formed on an underside of the optical interconnect component 308 in the monolithic block of fused silica 309 and arranged in a uniform 2D array. Each of the 2D curved micromirrors 340 of the optical interconnect component 308 is aligned with, but separated from, an end 344 of a corresponding one of the plurality of integrated optical waveguides 336.

The optical interconnect component 308 also includes one or more alignment features in the form of a pair of alignment holes 346 formed in the monolithic block of fused silica 309 for use in aligning the optical interconnect component 308 and the optical fibre connector ferrule 310. The optical interconnect component 308 also includes one or more mechanical features in the form of a pair of notches 372 formed in the monolithic block of fused silica 309 for engagement by one or more arms, clips or clamps (not shown) of the optical fibre connector ferrule 310 so as to connect, latch or hold the optical interconnect component 308 and the optical fibre connector ferrule 310 together and thereby detachably attach the optical interconnect component 308 and the optical fibre connector ferrule 310.

As will be understood from the foregoing description of FIGS. 4A and 4B, the plurality of integrated optical waveguides 336 of the optical interconnect component 308 are arranged to route light between the uniform 1D array of optical ports 338 of the optical interconnect component 308 and the uniform 2D array of 2D curved micromirrors 340. Specifically, alternate integrated optical waveguides 336 are used to route light up and down in Z to address 2D curved micromirrors 340 in different columns of the 2D array of 2D curved micromirrors 340.

The optical fibre connector ferrule 310 is formed in a monolithic block of material in the form of a monolithic block of fused silica 311 and includes a plurality of optical beam management elements in the form of a plurality of 2D curved total internal reflection (TIR) micromirrors 350 formed in an upper surface of the optical fibre connector ferrule 310 and arranged in a uniform 2D array. The spatial configuration of the 2D array of 2D curved micromirrors 350 of the optical fibre connector ferrule 310 matches the spatial configuration of the 2D array of 2D curved micromirrors 340 of the optical interconnect component 308.

The optical fibre connector ferrule 310 further includes a plurality of optical fibre alignment structures in the form of a uniform 2D array of optical fibre alignment holes 360 formed in the monolithic block of fused silica 311, each optical fibre alignment hole 360 being configured to accommodate an end section of a corresponding optical fibre 306 so that an end 307 of the corresponding optical fibre 306 is aligned with, but separated from, a corresponding one of the 2D curved micromirrors 350 of the optical fibre connector ferrule 310. Moreover, although not shown in FIG. 4A, the optical fibre connector ferrule 310 includes one or more passages or channels extending between a surface of the optical fibre connector ferrule 310 and each optical fibre alignment hole 360 to assist with the flow of an adhesive fluid such as epoxy for the attachment of each optical fibre 306 in the corresponding optical fibre alignment hole 360.

The optical fibre connector ferrule 310 further includes pins 370 formed in the monolithic block of fused silica 311, wherein each pin 370 is configured to be received in a corresponding one of the holes 346 of the optical interconnect component 308 for the passive alignment of the optical interconnect component 308 and the optical fibre connector ferrule 310. Specifically, the alignment holes 346 of the optical interconnect component 308 are positioned relative to the 2D curved micromirrors 340 of the optical interconnect component 308, and the pins 370 of the optical fibre connector ferrule 310 are positioned relative to the 2D curved micromirrors 350 of the optical fibre connector ferrule 310 to ensure that the 2D curved micromirrors 340 of the optical interconnect component 308 and the 2D curved micromirrors 350 of the optical fibre connector ferrule 310 are passively aligned when the pins 370 of the optical fibre connector ferrule 310 are inserted into the alignment holes 346 of the optical interconnect component 308.

Although not shown in FIG. 4A, it should be understood that the optical fibre connector ferrule 310 also includes one or more mechanical features such as one or more arms, clips or clamps (not shown) which are complementary to the notches 372 of the optical interconnect component 308 and which are configured to engage the notches 372 of the optical interconnect component 308 to connect, latch or hold the optical interconnect component 308 and the optical fibre connector ferrule 310 together and thereby detachably attach the optical interconnect component 308 and the optical fibre connector ferrule 310.

In use, when the pins 370 of the optical fibre connector ferrule 310 are inserted into the alignment holes 346 of the optical interconnect component 308, light is transmitted between integrated optical waveguides of the photonic integrated circuit and the optical fibres 306 via the optical interconnect component 308 and the optical fibre connector ferrule 310. The 2D array of 2D curved micromirrors 340 of the optical interconnect component 308 and the 2D array of 2D curved micromirrors 350 of the optical fibre connector ferrule 310 serve to form a 2D array of expanded collimated optical beams which are transmitted vertically between the optical interconnect component 308 and the optical fibre connector ferrule 310 thereby relaxing the alignment tolerance required between the optical interconnect component 308 and the optical fibre connector ferrule 310 for a given optical coupling efficiency.

From the foregoing description, it will be understood that the optical interconnect component 308 and the optical fibre connector ferrule 310 serve to optically couple a uniform 1D array of optical ports of a photonic integrated circuit and the uniform 2D array of optical fibres 306 thereby enabling higher density optical I/O than the optical I/O densities achievable using prior art optical interconnects. Moreover, the optical fibre connector ferrule 310 is pluggable or connectable to the optical interconnect component 308 in a vertical direction i.e. in a direction which is perpendicular to a direction between the photonic integrated circuit and the optical interconnect component 308. This may be advantageous because plugging or unplugging the optical fibre connector ferrule 310 and the optical interconnect component 308 may exert forces which are perpendicular to the direction between the photonic integrated circuit and the optical interconnect component 308, thereby exerting less force on a bond-line between the photonic integrated circuit and the optical interconnect component 308 and, optionally, also exerting less force on the photonic integrated circuit. Moreover, it should be understood that the photonic integrated circuit may extend at least partially underneath the optical interconnect component 308 so as to support the optical interconnect component 308 when the optical fibre connector ferrule 310 and the optical interconnect component 308 are plugged or unplugged.

FIG. 5 shows a schematic side view of part of a fifth optical interconnect assembly generally designated 402 for transmitting light between a photonic integrated circuit in the form of a silicon photonic integrated circuit (not shown) and a plurality of optical fibres 406 which shares many like features with the fourth optical interconnect assembly 302 of FIGS. 4A and 4B, with the features of the fifth optical interconnect assembly 402 of FIG. 5 having the same reference numerals as like features of the fourth optical interconnect assembly 302 of FIGS. 4A and 4B incremented by “100”. The optical interconnect assembly 402 includes an optical interconnect component 408 and an optical fibre connector ferrule 410. The optical interconnect component 408 is formed in a monolithic block of material in the form of a monolithic block of fused silica 409 and includes a plurality of integrated optical waveguides 436 and a plurality of 2D curved micromirrors 440 formed in an upper surface of the optical interconnect component 408. The plurality of 2D curved micromirrors 440 are arranged in a uniform 2D array like the uniform 2D array of 2D curved micromirrors 340 shown in FIG. 4B. Each of the 2D curved micromirrors 440 of the optical interconnect component 408 is aligned with, but separated from, an end 444 of a corresponding integrated optical waveguide 436. The optical fibre connector ferrule 410 is formed in a monolithic block of material in the form of a monolithic block of fused silica 411 and includes a plurality of 2D curved micromirrors 450 formed in a lower surface of the optical fibre connector ferrule 410 and arranged in a uniform 2D array which matches the uniform 2D array of the 2D curved micromirrors 440. The optical fibre connector ferrule 410 further includes a plurality of optical fibre alignment structures in the form of a uniform 2D array of optical fibre alignment holes 460. Each of the 2D curved micromirrors 450 of the optical fibre connector ferrule 410 is aligned with, but separated from, an end 407 of a corresponding optical fibre 406 located in a corresponding optical fibre alignment hole 460.

The optical interconnect component 408 includes alignment holes 446 formed in the monolithic block of fused silica 409 for use in aligning the optical interconnect component 408 and the optical fibre connector ferrule 410. The optical fibre connector ferrule 410 includes pins 470 formed in the monolithic block of fused silica 411 for use in aligning the optical interconnect component 408 and the optical fibre connector ferrule 410. Specifically, the alignment holes 446 of the optical interconnect component 408 are positioned relative to the microlenses 440 of the optical interconnect component 408, and the pins 470 of the optical fibre connector ferrule 410 are positioned relative to the microlenses 450 of the optical fibre connector ferrule 410 to ensure that the microlenses 440 of the optical interconnect component 408 and the microlenses 450 of the optical fibre connector ferrule 410 are passively aligned when the pins 470 of the optical fibre connector ferrule 410 are inserted into the alignment holes 446 of the optical interconnect component 408.

In use, when the pins 470 of the optical fibre connector ferrule 410 are inserted into the alignment holes 446 of the optical interconnect component 408, light is transmitted between the integrated optical waveguides of the photonic integrated circuit and the optical fibres 406 via the optical interconnect component 408 and the optical fibre connector ferrule 410. The 2D array of microlenses 440 of the optical interconnect component 408 and the 2D array of microlenses 450 of the optical fibre connector ferrule 410 serve to form a 2D array of expanded collimated optical beams which are transmitted vertically between the optical interconnect component 408 and the optical fibre connector ferrule 410 thereby relaxing the alignment tolerance required between the optical interconnect component 408 and the optical fibre connector ferrule 410 for a given optical coupling efficiency.

In other aspects, the fifth optical interconnect assembly 402 of FIG. 5 resembles the fourth optical interconnect assembly 302 of FIG. 4A.

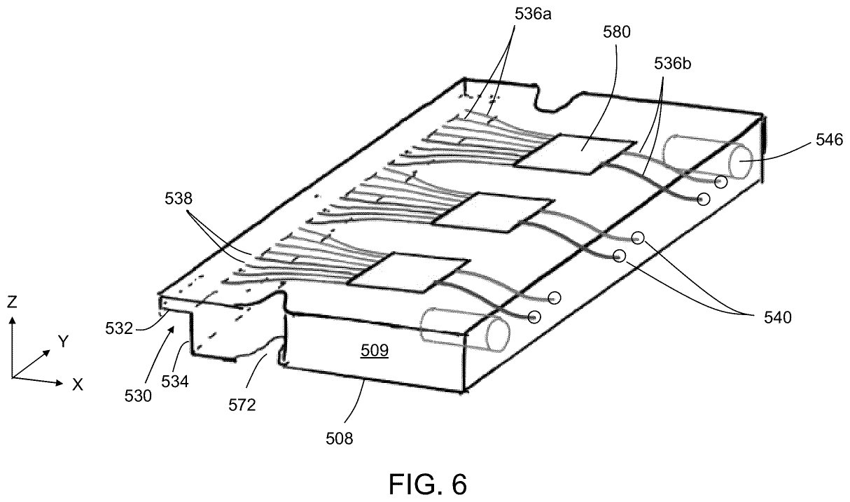

FIG. 6 shows a wavelength multiplexing or a wavelength demultiplexing optical interconnect component generally designated 508 for transmitting light between a photonic integrated circuit in the form of a silicon photonic integrated circuit (not shown) and one or more optical fibres (not shown) attached to an optical fibre connector ferrule (not shown). The wavelength mux/demux optical interconnect component 508 and the optical fibre connector ferrule are pluggable or connectable i.e. the wavelength mux/demux optical interconnect component 508 and the optical fibre connector ferrule are configured to be detachably attached.

The wavelength mux/demux optical interconnect component 508 is formed in a monolithic block of material in the form of a monolithic block of fused silica 509 and includes a step generally designated 530 formed at an edge of the wavelength mux/demux optical interconnect component 508. The step 530 includes a ledge 532 and a facet 534, wherein the facet 534 is configured for engagement with a facet of a photonic integrated circuit. One of ordinary skill in the art will understand that the ledge 532 and/or the facet 534 of the wavelength mux/demux optical interconnect component 508 may be formed by etching the monolithic block of fused silica 509.

The wavelength mux/demux optical interconnect component 508 further comprises a plurality of primary integrated optical waveguides 536a, a plurality of secondary integrated optical waveguides 536ba and a dispersive element 580 in the form of an AWG formed in the monolithic block of fused silica 509.

Each primary integrated optical waveguide 536a of the wavelength mux/demux optical interconnect component 508 ends at the facet 534 of the wavelength mux/demux optical interconnect component 508 so as to define a corresponding optical port 538 at the facet 534 of the wavelength mux/demux optical interconnect component 508. Each primary optical waveguide 536a extends from a corresponding one of the optical ports 538 to the dispersive element 580. The plurality of primary integrated optical waveguides 536a are configured so that the optical ports 538 are arranged in a uniform 1D array which has a spatial configuration which matches a spatial configuration of a uniform 1D array of optical ports of the photonic integrated circuit. Each optical port 538 of the wavelength mux/demux optical interconnect component 508 is defined at a predetermined distance from the ledge 532 of the wavelength mux/demux optical interconnect component 508. One of ordinary skill in the art will understand that the step 530 of the wavelength mux/demux optical interconnect component 508 is configured to allow engagement between the ledge 532 of the wavelength mux/demux optical interconnect component 508 and an upper reference surface of the photonic integrated circuit without a ledge of the photonic integrated circuit engaging the wavelength mux/demux optical interconnect component 508. As described above in relation to the photonic integrated circuit 4 and the interconnect component 8 with reference to FIGS. 1A-1C, this should result in the alignment of a plurality of optical ports of the photonic integrated circuit and the optical ports 538 of the wavelength mux/demux optical interconnect component 508 in the Z-direction when the ledge 532 of the wavelength mux/demux optical interconnect component 508 engages the upper reference surface of the photonic integrated circuit.

As described above in relation to the photonic integrated circuit 4 and the interconnect component 8 with reference to FIGS. 1A-1C, alignment of the wavelength mux/demux optical interconnect component 508 and the photonic integrated circuit in X and Y may be achieved using fiducial markers and a vision system. Alternatively, the wavelength mux/demux optical interconnect component 508 and the photonic integrated circuit may comprise one or more complementary alignment features configured for inter-engagement so as to align the wavelength mux/demux optical interconnect component 508 and the photonic integrated circuit in X and Y.

The optical interconnect component 508 further includes a plurality of optical beam management elements in the form of a plurality of microlenses 540 formed on an end surface of the optical interconnect component 508 in the monolithic block of fused silica 509. Each secondary optical waveguide 536b extends from the dispersive element 580. Each of the microlenses 540 of the optical interconnect component 508 is aligned with, but separated from, an end of a corresponding one of the plurality of secondary integrated optical waveguides 536b.

The optical interconnect component 508 also includes one or more alignment features in the form of a pair of alignment holes 546 formed in the monolithic block of fused silica 509 for use in aligning the optical interconnect component 508 and an optical fibre connector ferrule (not shown). The optical interconnect component 508 also includes one or more mechanical features in the form of a pair of notches 572 formed in the monolithic block of fused silica 509 for engagement by one or more arms, clips or clamps of an optical fibre connector ferrule (not shown) so as to connect, latch or hold the optical interconnect component 508 and the optical fibre connector ferrule together and thereby detachably attach the optical interconnect component 508 and the optical fibre connector ferrule.

In use, the dispersive element 580 receives a plurality of different wavelengths via different primary integrated optical waveguides 536a and multiplexes the plurality of different wavelengths into one or more of the secondary integrated optical waveguides 536b or the dispersive element 580 receives a plurality of different wavelengths via one of the secondary integrated optical waveguides 536b and demultiplexes the plurality of different wavelengths into different primary integrated optical waveguides 536a of the plurality of primary integrated optical waveguides 536a.

From the foregoing description of the wavelength mux/demux optical interconnect component 508, it will be understood that the optical interconnect component 508 and the optical fibre connector ferrule (not shown) serve to optically couple a uniform 1D array of optical ports of a photonic integrated circuit and one or more optical fibres thereby enabling higher density optical I/O than the optical I/O densities achievable using prior art optical interconnects whilst also providing optical wavelength mux/demux functionality. Moreover, the optical fibre connector ferrule is pluggable or connectable to the optical interconnect component 508 in a horizontal direction i.e. in a direction which is parallel to a direction between the photonic integrated circuit and the optical interconnect component 508.

In other respects the structure and operation of the wavelength mux/demux optical interconnect component 508 of FIG. 6 resembles the structure and operation of the optical interconnect component 8 of FIGS. 1A-1C.

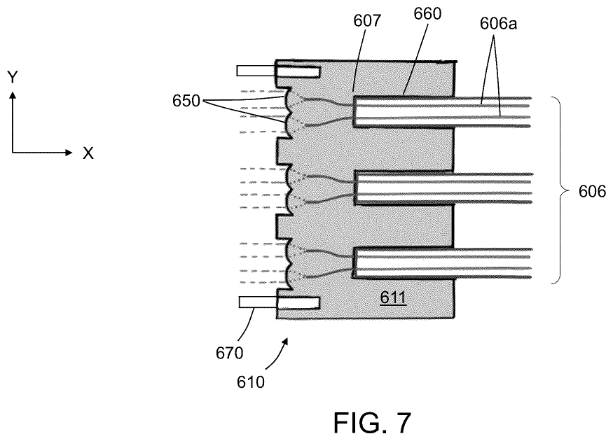

Referring now to FIG. 7 there is shown an optical fibre connector ferrule 610 formed in a monolithic block of material in the form of a monolithic block of fused silica 611 for transmitting light between an optical interconnect component (not shown) and a plurality of optical fibres 606, wherein each optical fibre 606 includes a plurality of optical fibre cores 606a. The optical fibre connector ferrule 610 includes a plurality of optical beam management elements in the form of a plurality of microlenses 650 formed in the monolithic block of fused silica 611, each microlens 650 configured for alignment with a corresponding microlens 40 of the optical interconnect component 8 of FIG. 1C. The optical fibre connector ferrule 610 further includes a plurality of optical fibre alignment structures in the form of a plurality of holes 660 formed in the monolithic block of fused silica 611, each hole 660 configured to receive an end section of a corresponding one of the optical fibres 606 so that each optical fibre core 606a at an end 607 of the corresponding optical fibre 606 is aligned with, but separated from, a corresponding one of the microlenses 650.

The optical fibre connector ferrule 610 is configured for connection to the optical interconnect component 8 so as to align each microlenses 650 of the optical fibre connector ferrule 610 with a corresponding microlens 40 of the optical interconnect component 8. The optical fibre connector ferrule 610 and the optical interconnect component 8 are configured to be pluggable or connectable. The optical fibre connector ferrule 610 and the optical interconnect component 8 may be configured to be detachably attached. The optical interconnect component 8 includes alignment holes 46 for use in aligning the optical interconnect component 8 and the optical fibre connector ferrule 610. The optical fibre connector ferrule 610 includes pins 670 formed in the monolithic block of fused silica 611 for use in aligning the optical interconnect component 8 and the optical fibre connector ferrule 610. Specifically, the alignment holes 46 of the optical interconnect component 8 are positioned relative to the microlenses 40 of the optical interconnect component 8, and the pins 670 of the optical fibre connector ferrule 610 are positioned relative to the microlenses 650 of the optical fibre connector ferrule 610 to ensure that the microlenses 40 of the optical interconnect component 8 and the microlenses 650 of the optical fibre connector ferrule 610 are passively aligned when the pins 670 of the optical fibre connector ferrule 610 are inserted into the alignment holes 46 of the optical interconnect component 8.

From the foregoing description of the optical fibre connector ferrule 610, it will be understood that the optical fibre connector ferrule 610 may be used in conjunction with the optical interconnect component 8 for optically coupling a uniform 1D array of optical ports of a photonic integrated circuit and one or more optical fibres thereby enabling higher density optical I/O than the optical I/O densities achievable using prior art optical interconnects. Moreover, the optical fibre connector ferrule 610 is pluggable or connectable to the optical interconnect component 8 in a horizontal direction i.e. in a direction which is parallel to a direction between the photonic integrated circuit and the optical interconnect component 8.

Formation of the optical interconnect component 8, 108, 208, 308, 408, 508 may comprise using a laser such as an ultrafast laser or a femtosecond laser to inscribe the monolithic block of material 9, 109, 209, 309, 409, 509 of the optical interconnect component 8, 108, 208, 308, 408, 508 in one or more regions so as to modify the material of the monolithic block 9, 109, 209, 309, 409, 509 of the optical interconnect component 8, 108, 208, 308, 408, 508 in the one or more regions.

For example, formation of each integrated optical waveguide 36, 136, 236, 336, 436, 536a, 536b may comprise using a laser such as an ultrafast laser or a femtosecond laser to inscribe the monolithic block of material 9, 109, 209, 309, 409, 509 in one or more integrated optical waveguide regions so as to modify the material of the monolithic block 9, 109, 209, 309, 409, 509 in the one or more integrated optical waveguide regions.

Formation of each optical beam management element 40, 140, 240, 340, 440, 540 may comprise using a laser such as an ultrafast laser or a femtosecond laser to inscribe the monolithic block of material 9, 109, 209, 309, 409, 509 in one or more optical beam management element regions so as to modify the material of the monolithic block 9, 109, 209, 309, 409, 509 in the one or more optical beam management element regions.

Formation of each optical beam management element 40, 140, 240, 340, 440, 540 may comprise using the laser to inscribe the monolithic block of material 9, 109, 209, 309, 409, 509 in the one or more optical beam management element regions so as to modify a refractive index of the material of the monolithic block 9, 109, 209, 309, 409, 509 in the one or more optical beam management element regions.

Formation of each optical beam management element 40, 140, 240, 340, 440, 540 may comprise using the laser to inscribe the monolithic block of material 9, 109, 209, 309, 409, 509 in the one or more optical beam management element regions so as to modify a chemical etchability of the material of the monolithic block 9, 109, 209, 309, 409, 509 in the one or more optical beam management element regions and subsequently removing the modified material of the monolithic block 9, 109, 209, 309, 409, 509 from the one or more optical beam management element regions, for example by chemical etching.

Formation of each optical beam management element 40, 140, 240, 340, 440, 540 may comprise using the laser to inscribe the monolithic block of material 9, 109, 209, 309, 409, 509 in the one or more optical beam management element regions so as to ablate the material of the monolithic block 9, 109, 209, 309, 409, 509 in the one or more optical beam management element regions.

One of ordinary skill in the art will understand that various modifications may be made to the embodiments of the present disclosure described above without departing from the scope of the present invention as defined according to the appended claims. For example, although many of the optical fiber connector ferrules 10, 110, 210, 310, 410 described above are configured for use with a uniform 2D array of optical fibres, other optical fiber connector ferrules may be configured for use with a uniform 1D array of optical fibres on a pitch which is greater than a pitch of the integrated optical waveguides of the photonic integrated circuit 4. In such an embodiment, the plurality of beam management elements of the optical fiber connector ferrule may be arranged in a uniform 1D array with each beam management element aligned with, but separated from, an end of a corresponding one of the optical fibres. The optical interconnect component may also comprise a plurality of beam management elements arranged in a uniform 1D array with the same pitch as the uniform 1D array of beam management elements of the optical fiber connector ferrule. Moreover, the plurality of integrated optical waveguides may fan-out from the plurality of optical ports of the optical interconnect component to the uniform 1D array of beam management elements of the optical interconnect component.

The ledges 32, 132, 332 of the optical interconnect components 8, 108, 308 are described with reference to FIGS. 1A-1C, 2A, 2B and 4A and 4B, as engaging an upper reference surface of a photonic integrated circuit without the optical interconnect components 8, 108, 308 engaging a ledge of the photonic integrated circuit so as to align a 1D array of optical ports 38, 138, 338 of the optical interconnect components 8, 108, 308 with a 1D array of optical ports of the photonic integrated circuit in Z. For example, with reference to FIGS. 1A-1C, the ledge 32 of the optical interconnect component 8 is described as engaging the upper reference surface 29 of the photonic integrated circuit 4 without the optical interconnect component 8 engaging the ledge 22 of the photonic integrated circuit 4 so as to align the 1D array of optical ports 38 of the optical interconnect component 8 with the 1D array of optical ports 28 of the photonic integrated circuit 4 in Z. In alternative embodiments, a ledge of the photonic integrated circuit may engage a lower reference surface of the optical interconnect component without the photonic integrated circuit engaging a ledge of the optical interconnect component so as to align the 1D array of optical ports 38, 138, 338 of the optical interconnect components 8, 108, 308 with a 1D array of optical ports 28 of the photonic integrated circuit in Z. For example, with reference to FIGS. 1A-1C, a ledge 22 of the photonic integrated circuit may engage a lower reference surface in the form of the underside of the optical interconnect component 8 without the photonic integrated circuit 4 engaging the ledge 32 of the optical interconnect component 8 so as to align the 1D array of optical ports 38, 138, 338 of the optical interconnect components 8, 108, 308 with a 1D array of optical ports 28 of the photonic integrated circuit 4 in Z.

In some embodiments, the facet of the photonic integrated circuit may be diced rather than etched. For example, the facet 24 of the photonic integrated circuit 4 may be diced rather than etched. In other embodiments, the photonic integrated circuit may not have a ledge, but may instead have just a facet.

In the embodiment of FIG. 6, the dispersive element 580 may comprise one or more higher refractive index integrated optical waveguides defined in a layer of higher refractive index material which is disposed on a lower refractive index substrate of the optical interconnect component 508. The one or more of the higher refractive index integrated optical waveguides may be configured for evanescent coupling with one or more of the primary integrated optical waveguides 536a and one or more of the higher refractive index integrated optical waveguides may be configured for evanescent coupling with one or more of the secondary integrated optical waveguides 536b. One or more of the higher refractive index integrated optical waveguides may be aligned with one or more of the primary integrated optical waveguides 536a and one or more of the higher refractive index integrated optical waveguides may be aligned with one or more of the secondary integrated optical waveguides 536b. Rather than the dispersive element being formed integrally with the optical interconnect component, the dispersive element may be formed separately from the optical interconnect component and then attached to the optical interconnect component, for example by flip-chip bonding. Rather than the dispersive element comprising an arrayed waveguide grating (AWG) 580, the dispersive element may comprise an Echelle grating or one or more bulk components such as one or more thin film interference filters located between the plurality of primary integrated optical waveguides 536a and one or more of the secondary integrated optical waveguide 536b.

As an alternative to the use of microlenses such as microlenses 40, 540, 50, 650 expanded collimated optical beams can be created using waveguide structures such as segmented waveguides or tapered waveguides. Alternatively, expanded collimated optical beams can be created using graded index (GRIN) lenses such as GRIN lenses made by the laser modification of the refractive index of a material such as glass or GRIN lenses made by inserting GRIN rods into holes which are laser etched into the optical interconnect component 8, 508 and/or the optical fibre connector ferrule 10, 610.

Although the optical interconnect components 108, 308 having 2D curved TIR micromirrors 140, 340 formed on a lower side thereof are described for use with optical fibre connector ferrules 110, 310 having 2D curved TIR micromirrors 150, 350 formed on an upper side thereof, the optical interconnect components 108, 308 may be used with the optical fibre connector ferrules 210, 410 having 2D curved micromirrors 250, 450 formed on a lower side thereof. Similarly, although the optical fibre connector ferrules 110, 310 having 2D curved TIR micromirrors 150, 350 formed on an upper side thereof are described for use with optical interconnect components 108, 308 having 2D curved TIR micromirrors 140, 340 formed on a lower side thereof, the optical fibre connector ferrules 110, 310 may be used with the optical interconnect components 208, 408 having 2D curved micromirrors 240, 440 formed on an upper side thereof.

Each feature disclosed or illustrated in the present specification may be incorporated in any embodiment, either alone, or in any appropriate combination with any other feature disclosed or illustrated herein. In particular, one of ordinary skill in the art will understand that one or more of the features of the embodiments of the present disclosure described above with reference to the drawings may produce effects or provide advantages when used in isolation from one or more of the other features of the embodiments of the present disclosure and that different combinations of the features are possible other than the specific combinations of the features of the embodiments of the present disclosure described above.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Use of the term “comprising” when used in relation to a feature of an embodiment of the present disclosure does not exclude other features or steps. Use of the term “a” or “an” when used in relation to a feature of an embodiment of the present disclosure does not exclude the possibility that the embodiment may include a plurality of such features.

The use of any reference signs in the claims should not be construed as limiting the scope of the claims.

1-25. (canceled)

26. An optical interconnect component comprising:
a step including a ledge and a facet;
one or more optical beam management elements formed in a surface of the optical interconnect component; and
a plurality of integrated optical waveguides, wherein individual of the plurality of integrated optical waveguides extend from the facet so as to define an optical port at the facet, the plurality of integrated optical waveguides defining a plurality of optical ports; and wherein individual of the one or more optical beam management elements is aligned with, but separated from, an end of a corresponding one of the plurality of integrated optical waveguides.

27. The optical interconnect component of claim 26, wherein one of the one or more optical beam management elements comprises:
an optical beam collimating element;
an optical beam focussing element;
a microlens;
a waveguide;
a graded index (GRIN) lens; or
a 2D curved micromirror.

28. The optical interconnect component of claim 26, wherein the plurality of optical ports is arranged in a 1D array.

29. The optical interconnect component of claim 26, wherein the optical interconnect component comprises fused silica.

30. The optical interconnect component of claim 26, comprising:
one or more alignment features, individual of the one or more alignment features being configured to engage a corresponding complementary alignment feature of a photonic integrated circuit for passive alignment of the optical interconnect component and the photonic integrated circuit; and
one or more further alignment features, individual of the one or more further alignment features being configured to engage a corresponding complementary alignment feature of an optical fibre ferrule component for passive alignment of the optical interconnect component and the optical fibre ferrule component.

31. The optical interconnect component of claim 26, wherein the one or more optical beam management elements comprise a plurality of optical beam management elements.

32. The optical interconnect component of claim 31, wherein:
the plurality of optical beam management elements comprises a 1D array of optical beam management elements;
the plurality of optical beam management elements comprises a staggered arrangement of optical beam management elements; or
the plurality of optical beam management elements comprises a 2D array of optical beam management elements.

33. The optical interconnect component of claim 26, comprising a dispersive element, wherein the plurality of integrated optical waveguides includes a plurality of primary integrated optical waveguides and a secondary integrated optical waveguide, wherein individual of the plurality of primary integrated optical waveguides extends from a corresponding one of the plurality of optical ports to the dispersive element, and wherein the secondary integrated optical waveguide extends from the dispersive element and ends at a position which is aligned with, but separated from, a corresponding one of the one or more optical beam management elements,
wherein the dispersive element is to receive a plurality of different wavelengths via different primary integrated optical waveguides of the plurality of primary integrated optical waveguides and multiplex the plurality of different wavelengths into the secondary integrated optical waveguide or to receive a plurality of different wavelengths via the secondary integrated optical waveguide and demultiplex the plurality of different wavelengths into different primary integrated optical waveguides of the plurality of primary integrated optical waveguides.

34. The optical interconnect component of claim 33, wherein the dispersive element comprises an arrayed waveguide grating (AWG) or an Echelle grating.

35. An optical fibre connector ferrule comprising:
one or more optical beam management elements, individual of the one or more optical beam management elements to align with a corresponding optical beam management element of an optical interconnect component; and
one or more optical fibre alignment structures, wherein individual of the one or more optical fibre alignment structures is configured for engagement with a corresponding optical fibre so that an end of the corresponding optical fibre is aligned with, but separated from, a corresponding one of the one or more optical beam management elements of the optical fibre connector ferrule.

36. The optical fibre connector ferrule as claimed in claim 35, wherein one of the one or more optical beam management elements of the optical fibre connector ferrule comprises:
an optical beam collimating element;
an optical beam focussing element;
a microlens;
a waveguide; or
a 2D curved micromirror.

37. An optical interconnect assembly comprising:
an optical interconnect component comprising:
a step including a ledge and a facet;
one or more optical beam management elements formed in a surface of the optical interconnect component; and
a plurality of integrated optical waveguides, wherein individual of the plurality of integrated optical waveguides extend from the facet so as to define an optical port at the facet, the plurality of integrated optical waveguides defining a plurality of optical ports; and wherein individual of the one or more optical beam management elements is aligned with, but separated from, an end of a corresponding one of the plurality of integrated optical waveguides; and
an optical fibre connector ferrule comprising:
one or more optical beam management elements, individual of the one or more optical beam management elements to align with a corresponding optical beam management element of an optical interconnect component; and
one or more optical fibre alignment structures, wherein individual of the one or more optical fibre alignment structures is configured for engagement with a corresponding optical fibre so that an end of the corresponding optical fibre is aligned with, but separated from, a corresponding one of the one or more optical beam management elements of the optical fibre connector ferrule, wherein individual of the one or more optical beam management elements of the optical interconnect component is aligned with a corresponding optical beam management element of the optical fibre connector ferrule.

38. The optical interconnect assembly as claimed in claim 37, wherein the one or more optical beam management elements of the optical fibre connector ferrule have a spatial configuration which matches a spatial configuration of the one or more optical beam management elements of the optical interconnect component; and wherein the optical fibre connector ferrule and the optical interconnect component are aligned so that individual of the one or more optical beam management elements of the optical fibre connector ferrule is aligned with a corresponding optical beam management element of the optical interconnect component for transmission of light between individual of the one or more optical beam management elements of the optical interconnect component and a corresponding optical beam management element of the optical fibre connector ferrule.

39. The optical interconnect assembly as claimed in claim 37, wherein the optical fibre connector ferrule and the optical interconnect component are detachably attached.

40. The optical interconnect assembly as claimed in claim 37, wherein the optical interconnect component and the optical fibre connector ferrule have one or more complementary inter-engaging alignment features for passive alignment of the optical interconnect component and the optical fibre connector ferrule.

41. An optical system comprising the optical interconnect assembly as claimed in claim 37, a photonic integrated circuit, and one or more optical fibres, wherein the photonic integrated circuit and the optical interconnect component are attached and individual of the one or more optical fibres are attached to a corresponding optical fibre alignment structure of the optical fibre connector ferrule.

42. The optical system as claimed in claim 41, wherein the photonic integrated circuit comprises a plurality of integrated optical waveguides and a step formed at an edge of the photonic integrated circuit, wherein the step includes a ledge and a facet, and wherein individual of the plurality of integrated optical waveguides of the photonic integrated circuit ends at the facet of the photonic integrated circuit so as to define a corresponding optical port at the facet of the photonic integrated circuit, the plurality of integrated optical waveguides of the photonic integrated circuit defining a plurality of optical ports.

43. The optical system as claimed in claim 42, wherein the plurality of optical ports of the optical interconnect component and the ledge of the optical interconnect component are separated by a first distance that matches a second distance by which the plurality of optical ports of the photonic integrated circuit and a surface of the photonic integrated circuit are separated, and wherein the step of the optical interconnect component is configured to allow engagement between the ledge of the optical interconnect component and the surface of the photonic integrated circuit without the ledge of the photonic integrated circuit engaging the optical interconnect component.

44. The optical system as claimed in claim 42, wherein the surface of the optical interconnect component is a first surface of the optical interconnect component, the plurality of optical ports of the optical interconnect component and a second surface of the optical interconnect component are separated by a first distance that matches a second distance by which the plurality of optical ports of the photonic integrated circuit and the ledge of the photonic integrated circuit are separated, and wherein the step of the optical interconnect component is configured to allow engagement between the second surface of the optical interconnect component and the ledge of the photonic integrated circuit without the ledge of the optical interconnect component engaging the photonic integrated circuit.

45. The optical system as claimed in claim 41, wherein the one or more optical fibres comprise:
a plurality of optical fibres;
a 1D array of optical fibres;
a staggered arrangement of optical fibres; or
a 2D array of optical fibres.
